(19) United States
(12) Patent Application Publication
(10) Pub. No.: US 2012/0314656 A1
(43) Pub. Date: Dec. 13, 2012

(54) METHOD AND APPARATUS FOR COMBINING AND TRANSCEIVING CONTROL INFORMATION

(75) Inventors: Sungkwon Hong, Seoul (KR); Kibum Kwon, Ansan-si (KR); Kyoungmin Park, Goyang-si (KR)

(73) Assignee: PANTECH CO., LTD., Seoul (KR)

(21) Appl. No.: 13/520,515

(22) PCT Filed: Jan. 4, 2011
(86) PCT No.: PCT/KR2011/000025

§ 371 Date: Jul. 3, 2012

(30) Foreign Application Priority Data
Jan. 6, 2010 (KR) 10-2010-0000969

(51) Int. Cl. H04W 88/08

(52) U.S. Cl. 370/328

(57) ABSTRACT

Disclosed are a method and apparatus for combining and transceiving control information. The method for combining and transmitting control information in accordance with one embodiment of the present invention comprises: a step in which a base station, which transceives control information and data information to/from a user terminal via a plurality of component carriers (CC), transmits control information via a first component carrier to the user terminal, and determines identification information for identifying a second component carrier so as to transmit data information via the second component carrier which is determined by the control information of the first component carrier; a step of determining indication information required for encoding the data information and/or control information of the second component carrier; a step of combining the identification information for identifying the second component carrier and the indication information; and a step of transmitting the control information of the first component carrier, including said combined information.

### CROSS-REFERENCE TO RELATED APPLICATIONS

This application is the National Stage Entry of International Application No. PCT/KR2011/000025, filed on Jan. 4, 2011, and claims priority from and the benefit of Korean Patent Application No. 10-2010-0000969, filed on Jan. 6, 2010, both of which are hereby incorporated by reference for all purposed as if fully set forth herein.

### BACKGROUND

1. Field

The present invention relates to a method and apparatus for combining and transceiving control information in a wireless network.

2. Discussion of the Background

A wireless communication network environment that operates a plurality of component carriers (CCs) may separately operate a CC that transmits both control information and data and a CC that transmits only data excluding control information. In this instance, when an error occurs in the control information associated with the CC that transmits only data and the control information fails to be transmitted, there is difficulty in utilizing the entire information associated with the data that can be used through the control information. Accordingly, there is a desire for a process to improve a usability of data included in a CC.

### SUMMARY

Therefore, the present invention has been made in view of the above-mentioned problems, and an aspect of the present invention is to improve stability of transmission by sharing control information between carriers or transmitting control information through use of a carrier that is different from a carrier for data information for effective transmission of the control information in a wireless communication network environment operating a plurality of component carriers (CCs). Also, a decrease in efficiency of the data transmission caused by retransmission may be reduced by securing stability of the transmission.

In accordance with an aspect of the present invention, there is provided a method of combining and transmitting control information so as to enable a base station (BS) that performs transmission and reception of control information and data information with a user equipment (UE) through a plurality of component carriers (CCs) to transmit control information to the UE through a first CC and to transmit data information through a second CC identified by the control information of the first CC, the method including: determining identification information to identify the second CC; determining indication information required for decoding at least one of the data information and control information of the second CC; combining the identification information to identify the second CC with the indication information; and transmitting combined information by including the combined information in the control information of the first CC.

In accordance with another aspect of the present invention, there is provided a method of combining and transmitting control information so as to enable a BS that performs transmission and reception of control information and data information with a UE through a plurality of CCs to transmit control information and data information to the UE through a first CC, the method including: determining indication information; combining, with the indication information, identification information including control information associated with data information to be transmitted and received or a CC; and transmitting the combined information by including the combined information in the control information of the first CC.

In accordance with another aspect of the present invention, there is provided a method of combining and transmitting control information so as to enable a BS that performs transmission and reception of control information and data information with a UE through a plurality of CCs to transmit control information to the UE through a first CC and to transmit data information through a second CC identified by the control information, the method including: determining identification information to identify the second CC; combining, with the identification information, indication information including control information associated with information to be transmitted and received or a CC; and transmitting the combined information by including the combined information in the control information of the first CC.

In accordance with another aspect of the present invention, there is provided a method of combining and receiving control information so as to enable a UE that performs transmission and reception of control information and data information with a BS through a plurality of CCs to receive control information from the BS through a first CC and to receive data information through a second CC identified by the control information, the method including: decoding control information by receiving a signal including the control information through the first CC; extracting, from the decoded control information, identification information to identify the second CC; extracting, from the decoded control information, indication information to be used for decoding at least one of the data information and control information of the second CC; and decoding at least one of the data information and the control information of the second CC through use of the identification information and indication information.

In accordance with another aspect of the present invention, there is provided a method of combining and receiving control information to enable a UE that performs transmission and reception of control information and data information with a BS through a plurality of CCs to receive control information and data information, the method including: decoding control information by receiving a signal including the control information through a first CC; extracting indication information from the decoded control information; and extracting identification information including control information associated with information to be transmitted and received or a CC from the decoded control information when the indication information indicates that data is transmitted through the first CC.

In accordance with another aspect of the present invention, there is provided a method of combining and receiving control information to enable a UE that performs transmission and reception of control information and data information with a BS through a plurality of CCs to transmit control information through a first CC and to receive data information through a second CC identified by the control information, the method including: decoding control information by receiving a signal including the control information through the first CC; extracting identification information from the decoded control information; and extracting, from the decoded control information, indication information including control information associated with information to be transmitted and received or a CC when the identification information includes identification information to identify the second CC and the second CC is an extension carrier.

In accordance with another aspect of the present invention, there is provided an apparatus for combining and transmitting control information so as to enable a BS that performs transmission and reception of control information and data information with a UE through a plurality of CCs to transmit control information to the UE through a first CC and to transmit data information through a second CC identified by the control information of the first CC, the apparatus including: a control format indicator (CFI) determining unit to determine indication information to be used for decoding at least one of data and control information of the second CC; an identification information determining unit to determine identification information to identify the second CC; a control information combining unit to combine the indication information, identification information, and other control information; a signal generating unit to generate the combined information to be a wireless signal; and a transmitting unit to transmit the generated wireless signal.

In accordance with another aspect of the present invention, there is provided an apparatus for combining and receiving control information to enable a UE that performs transmission and reception of control information and data information with a BS through a plurality of CCs to receive control information from the BS through a first CC, and to receive data information through a second CC identified by the control information, the apparatus including: a receiving unit to receive a signal including control information through the first CC; a signal decoding unit to decode the received signal into the control information; an identification information extracting unit to extract identification information to identify the second CC from the decoded control information; a CFI extracting unit to extract, from the decoded control information, indication information to be used for decoding at least one of data and control information of the second CC; and a control information extracting unit to extract, from the decoded control information, information excluding the identification information and the indication information, and the signal decoding unit decodes at least one of the data and the control information of the second CC through use of the identification information and the indication information.

In accordance with another aspect of the present invention, there is provided a method of combining and transmitting control information to enable a BS that performs transmission and reception of control information and data information with a UE through a plurality of CCs to transmit control information to the UE through a first CC, and to transmit data information through a second CC identified by the control information of the first CC, the method including: calculating identification information j_{new} to identify the second CC through use of identification information i_{CC}_{_{—}}_{X} associated with the first CC and existing identification information j associated with the second CC; and transmitting the identification information j_{new} to identify the second CC by including the identification information j_{new} in the control information of the first CC, and the identification information j_{new} is calculated to have a number in a range smaller than j based on j and i_{CC}_{_{—}}_{X}.

In accordance with another aspect of the present invention, there is provided a method of combining and receiving control information to enable a UE that performs transmission and reception of control information and data information with a BS through a plurality of CCs to receive control information through a first CC, and to receive data information through a second CC identified by the control information, the method including: decoding control information by receiving a signal including the control information through the first CC; calculating an existing identification number j associated with the second CC from the decoded control information j_{new} through use of identification information i_{CC}_{_{—}}_{X} associated with the first CC; and receiving data information through the second CC indicated by the calculated j, and j is a number in a range greater than or equal to j_{new}.

Embodiments of the present invention may combine control information required for utilizing a plurality of component carriers (CCs), such as a CI from among control information, with resource allocation information in a CC such as control format indicator (CFI), and may include the combined information in control information such as a physical downlink control channel (PDCCH) and thus, may remove an error that may occur in a control information transceiving process of a CC and may improve transmission efficiency. Also, a data region may prevent an unnecessary hybrid automatic repeat request (HARQ) when an error does not occur and thus, may prevent wasting of wireless resources.

Also, a region of control information that is not required during inter-CC scheduling may transmit predetermined control information.

### BRIEF DESCRIPTION OF THE DRAWINGS

FIG. 1 is a diagram illustrating an error of control information that occurs in a network using a plurality of component carriers (CCs) according to an embodiment of the present invention;

FIG. 2 is a diagram illustrating a configuration of a field according to an embodiment of the present invention;

FIG. 3 is a diagram illustrating an example of a field in which a carrier indicator (CI) and a control format indicator (CFI) are combined according to an embodiment of the present invention;

FIG. 4 is a diagram illustrating a configuration of a CI according to an embodiment of the present invention;

FIG. 5 is a diagram illustrating an example of a field in which a CI and a CFI are combined according to an embodiment of the present invention;

FIG. 6 is a diagram illustrating an example of a field in which a CI and a CFI are combined according to another embodiment of the present invention;

FIG. 7 is a diagram illustrating inter-CC scheduling according to an embodiment of the present invention;

FIG. 8 is a diagram illustrating a case in which a control channel is not included in an extension carrier according to another embodiment of the present invention;

FIG. 9 is a diagram illustrating an example in which a CFI and a CI are combined and provided when a number of CCs is N according to an embodiment of the present invention;

FIG. 10 is a diagram illustrating a value set in a field when a number of CCs is 6 and a CFI includes three types of information according to an embodiment of the present invention;

FIG. 11 is a diagram illustrating a process of generating downlink (DL) control information in a base station according to an embodiment of the present invention;

FIG. 12 is a diagram illustrating a process of generating control information in a base station according to an embodiment of the present invention;

FIG. 13 is a diagram illustrating a process of decoding control information in a UE according to an embodiment of the present invention; and

FIG. 14 is a diagram illustrating a configuration of a UE according to an embodiment of the present invention.

400: configuration of a CC

500, 600, 900, 1000: an example of a field in which identification information corresponding to a CI and a CFI are combined

1190: signal generating unit

1101: CFI determining unit

1102: identification information determining unit

1490: signal decoding unit

1450: CFI extracting unit

1460: identification information extracting unit

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

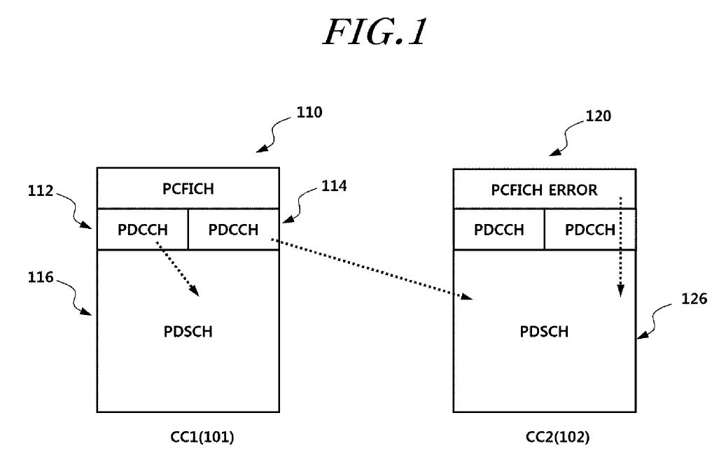

FIG. 1 illustrates an error of control information that may occur in a network using a plurality of component carriers (CCs). FIG. 1 illustrates a structure in which data is transmitted through use of two CCs. As an example of a configuration of a network that uses a plurality of CCs, 3GPP Long Term Evolution-Advanced (LTE-A) may use a standard based on a single carrier as a base, and has proposed coupling of a few bands having a bandwidth of 20 megahertz (MHz) or less. 3GPP LTE-A has discussed a multiple-carrier aggregation by taking backward compatibility into consideration based on the base standard of 3GPP LTE. The important issue in the discussion of the carrier aggregation may be how to extend a control channel and how to form a data channel, as a number of CCs increases.

FIG. 1 shows that a system using a plurality of CCs in which a physical downlink control channel (PDCCH) 114 corresponding to a physical channel of a first CC (CC1) 101 includes information associated with data information (a physical downlink shared channel (PHSCH)) of a second CC (CC2) 102. CC1 101 of FIG. 1 may be configured of a physical control format indicator channel (PCFICH) 110, PDCCHs 112 and 114, and a PDSCH 116. Among the elements, the PCFICH may be a control format indicator channel, and may inform a user equipment (UE) of how many OFDM symbols are allocated to a control channel. The PCFICH may be configured of a value of control format indicator (CFI), and the value of the CFI may have a value in a range of 1 through 3 when a number of resource block groups of the entire band of a downlink (DL) is greater than 10, and may have a value in a range of 2 through 4 and may be expressed by 2 bits when the number of resource block groups is less than or equal to 10. When an error occurs in the PCFICH, an error may occur in a PDCCH, and accordingly, an error may occur in a PDSCH corresponding to a resource allocated by the PDCCH.

This may be applicable to a case in which a plurality of CCs is used as illustrated in FIG. 1.

The PDCCHs 112 and 114 of FIG. 1 may inform the UE of resource allocation information determined by a base station such as an eNB in a downlink (DL) or uplink (UL) channel for each subframe. In the carrier aggregation process using the plurality of CCs, a CC including a control channel and a CC excluding a control channel may exist separately, and a PDCCH may indicate the PDSCH 116 included in the CC 101 where the PDCCH 112 is included, like the PDCCH 112, or may provide cross-carrier scheduling information indicating another CC 102, like the PDCCH 114. Also, information associated with PCFICH 120 may need to be determined to determine a PDSCH 126 in CC2. Accordingly, when an error occurs in the PCFICH 120 in the process, there is difficulty in accessing the PDSCH 126. That is, the scheduling information provided by the PDCCH may include information associated with resource allocation in the same CC such as the PDCCH 112, and information associated with resources of another CC such as the PDCCH 114. According to a method of scheduling CCs for providing resource allocation information of another CC, information associated with a carrier indicator (CI) corresponding to identification information to indicate another CC, that is, to identify the other CC, may be included in a downlink control indicator (DCI) of the PDCCH. The CI may be variously allocated based on a number of carriers. When the number of CCs is limited to 5, each CC may have a value in a range of 0 through 4 or in a range of 1 through 5. A UE may use data information based on another CC through DCI information included in the PDCCH. In this instance, when an error occurs in a PCFICH of the other CC, there is difficulty in using the data information. This will be described in detail as follows.

Referring to FIG. 1, CC1 101 may perform inter-CC scheduling with respect to CC2 102. The PCFICH 110 of CC1 101 may indicate a number of OFDM symbols used for the PDCCHs 112 and 114, so as to enable the UE to access information of the PDCCHs. When an error rate of the PCFICH is lower than an error rate of the PDCCH, a probability of resource allocation being erroneously performed due to an error in the PCFICH and an error occurring in the PDSCH may be low. However, a channel state may vary between CCs. When a serious error occurs in the PCFICH 120 since a channel state of CC2 102 is poor, this may cause an error in the PDSCH 126 of CC2 102 directly indicated (identified) by the PDCCH 114 of CC1 101. The error of the PCFICH 120 may occur even though the PDCCH 114 of CC1 101 does not include an error, and an error of the PDSCH 126 caused by the error of the PCFICH 120 may create a hybrid automatic repeat request (HARQ) situation and may induce retransmission and thus, resources may be further wasted. This may cause a HARQ buffer corruption.

CC2 102 may include control information, for example a PDCCH. CC2 102 may include control information, and when the control information is a PDCCH, the PDCCH may indicate a PDSCH included in a CC where the PDCCH is included or may indicate a PDSCH included in a third CC based on inter-CC scheduling. That is, CC1 and CC2 may be distinguished based on whether a PDSCH indicated by a PDCCH of another CC is included, as opposed to whether control information is included.

Hereinafter, when an error occurs in a PCFICH according to an embodiment of the present invention, an information configuration will be described that includes information provided by the PCFICH in another CC so that the other CC may provide the information provided by the PCFICH to resolve the error in the PCFICH.

As described in the foregoing, an embodiment of the present invention may require a process of providing carrier scheduling information and including CFI information (in the carrier scheduling information). To include the CFI information (in the carrier scheduling information) a process of selecting each piece of information and setting corresponding information may be required.

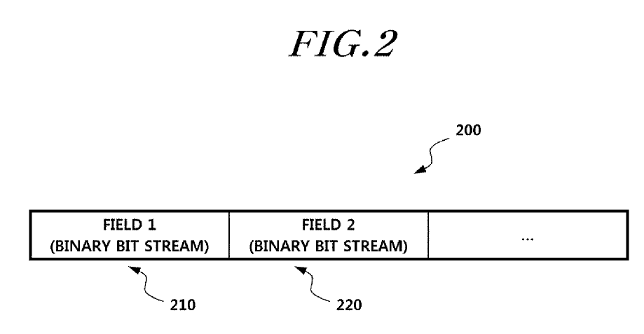

FIG. 2 illustrates a configuration of a field according to an embodiment of the present invention. A field 200 may indicate a predetermined region in a bit stream set formed of binary bits. Consecutive numbers in a range of 0 through (2^{k}−1) or in a range of 1 through (2^{k}) may be assigned in the field. Here, k denotes a number of bits in the field and a length of the field. A single large field may be divided into a few small fields 210 and 220. The fields may be considered to be physically successive regions, or may be logically successive regions and may be dispersed in the large field where the fields belong to.

To describe an example of combining a CI and a CFI according to an embodiment of the present invention, the following items are defined.

A case in which a PDCCH is decoded in a predetermined CC, and resource allocation based on the decoded information is the same as a CC from which the decoded PDCCH is transmitted may be referred to as ‘case X’, as shown in the case of the PDCCH 112 of FIG. 1. In this case, the corresponding CC may be defined to be a ‘CC X’ and a corresponding PDCCH may be defined to be a ‘PDCCH X’. Also, a set of CCs different from the CC X may be defined to be a ‘CC set Y’.

According to an embodiment of the present invention, a CI may be set by distinguishing a first CC X and a CC set Y and applying different number systems to the first CC X and the CC set Y. In the case X, a PCFICH has been decoded and a PDCCH has been decoded accordingly, and successful decoding has already been determined by error detection by a CRC and thus, information associated with a CFI may not be required. Conversely, a CC included in the CC set Y, that is, a CC that may be designated by inter-CC scheduling, may require information associated with the CFI. According to an embodiment of the present invention, a CC included in the CC set Y may include data information such as a PDSCH, and control information required for decoding the data information, for example, a PDCCH, may be included in another CC.

According to an embodiment of the present invention, a case in which a number of current CCs X is a(=1), a number of CC sets Y is b(=4), and a number of CFIs is c(=3), will be described.

According to an embodiment of the present invention, the same number system may be applied to a CFI of a CC X and a CFI of a CC set Y. For this, information may be configured within one field.

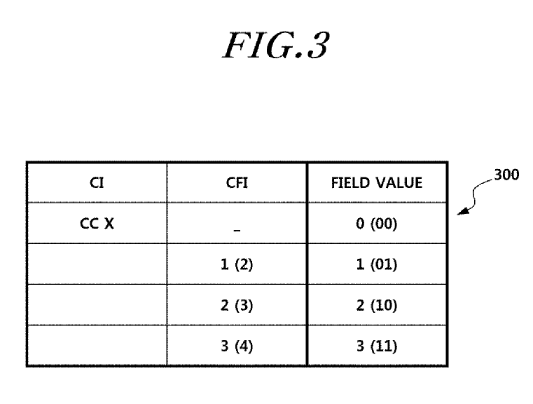

The number of CCs X may be 1, the CC X may be any value in a newly configured field, and a value of the CFI may be designated to be different from an existing system (1 through 3). When the CFI has a value in a range of 1 through 3, a CC including a decoded PDCCH may be designated to be “0”, and a field of 2 bits may be configured by using a value of each CFI (1 through 3) as it is. According to another embodiment of the present invention, a value of the CFI may be 2 through 4. This will be described with reference to FIG. 3.

FIG. 3 illustrates an example of a field in which a CI and a CFI are combined. When the CI is a CC X, the CFI may not be set separately. When the CFI is decoded well, a PDCCH of the CC X may be decoded. Accordingly, when the PDCCH of the CC X is decoded, the UE is already aware of a value of the CFI. Therefore, in a case of the CC X, 00 may be assigned as shown in 300 of FIG. 3. In other cases, values of 01, 10, and 11 may be designated to the field so that the CFIs have values of 1 through 3 (2 through 4).

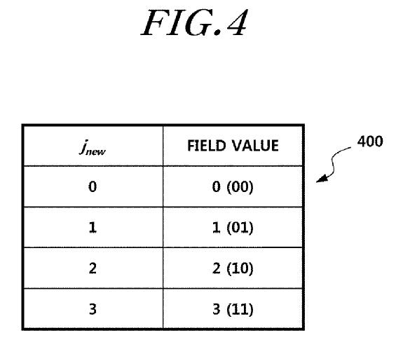

FIG. 4 illustrates a configuration of a CI according to an embodiment of the present invention. A CI may use a plurality of CCs as described in the foregoing, and may identify a second CC so that a PDCCH included in a first CC indicates that a data channel is assigned to the second CC. That is, according to an embodiment of the present invention, the CI may be identification information of the second CC. As described in the foregoing, a CI of a CC set Y may be configured by one-to-one conversion of a value expressed by an existing CI. CCs expressed by the existing CI may have values in a range of 0 through 4, and a total number of the CCs is d. A CC of which a current PDCCH is decoded may have one of the values, and a number of remaining CCs is 4 and thus, typically, a number of CCs designated by inter-CC scheduling may be 4 and may be expressed by 2 bits. However, the number of CCs may be increased or decreased, and a number of assigned bits may be adjusted accordingly. Two number systems are different from each other and may be configured to have a conversion-relationship. When the two number systems provide one-to-one correspondence, up to 4! conversion-relationships may be provided. Among the conversion-relationships, there is a relationship that is expressed by a simple equation as expressed by Equation 1.

j_{new}=(j−i_{CC}_{_{—}}_{X}+d−1)%(d−1) [Equation 1]

In Equation 1, j may be 0, . . . , and d−1, j_{new} denotes a number (a new CI) for indicating a new carrier, j may denote a number (an existing CI) for indicating a carrier based on an existing scheme, and i_{CC}_{_{—}}_{X} denotes an existing system number of a CC X. % denotes a modular operation. According to an embodiment of the present invention, d may be 5 and may increase proportionally as a number of total CCs increases.

According to another embodiment of the present invention, a conversion-relation may be expressed by Equation 2.

jnew=j, (j<iCC_{—}X)

jnew=j−1, (j>i_{CC}_{_{—}}_{X}) [Equation 2]

j_{new} configured based on Equation 1 or Equation 2 may form a field as shown in 400 of FIG. 4.

When the CFI of FIG. 3 and the field of the CI of FIG. 4 are combined, a field in which CI information and CFI information are combined may be configured.

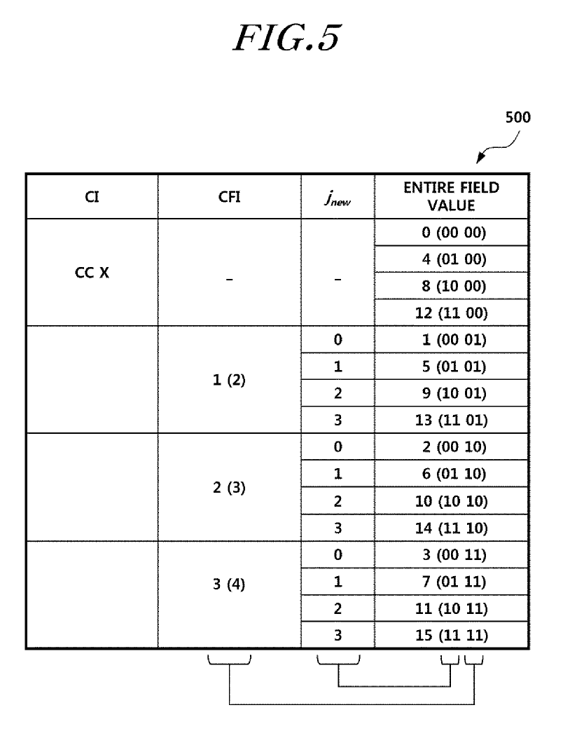

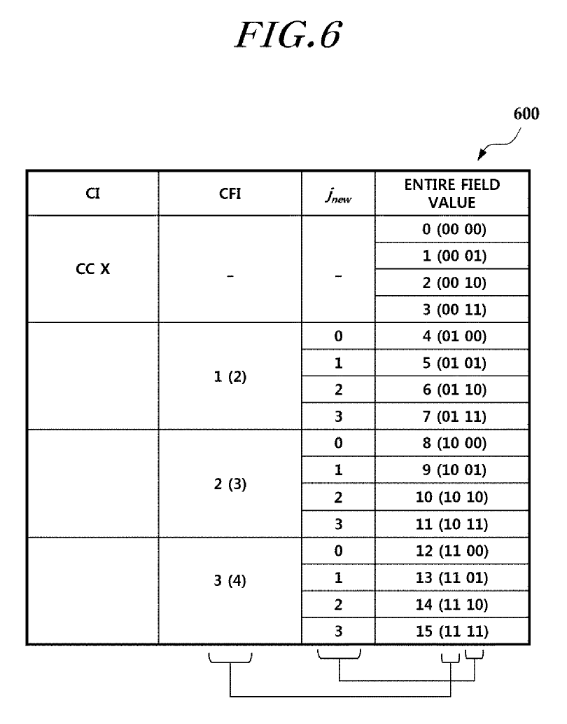

FIGS. 5 and 6 illustrate an example of a field in which a CI and a CFI are combined so that the CI and the CFI may be transmitted together. When a CI of 3 bits and a CFI of 2 bits are combined, 5 bits may be included in a PDCCH. When information is transmitted in a total of 4 bits as shown in FIGS. 5 and 6, resources allocated to the PDCCH may not be wasted and transmission efficiency may be improved. When a total number of combinations of information in an embodiment of the present invention is 15, an example in which information is configured in 4 bits through joint coding will be described with reference to FIGS. 5 and 6.

FIG. 5 illustrates an example of a field in which identification information corresponding to a CI and a CFI are combined according to an embodiment of the present invention. In 500, the first 2 bits of 4 bits may include identification information indicating a carrier, and the next 2 bits may include CFI information.

FIG. 6 illustrates an example of a field in which identification information corresponding to a CI and a CFI are combined according to another embodiment of the present invention. In 600, the first 2 bits of 4 bits may include CFI information, and the next 2 bits may include CI information.

When a control field is configured as shown in FIGS. 5 and 6, a CC X (case X) may not need to express CFI information and thus, the field may further include information of 2 bits. Accordingly, in the process of embodying the invention, additional information of 2 bits may be included, and an example of the information will be described.

A carrier aggregation may not include an extension carrier that does not include a PDCCH and receives resource allocation by another CC. In this example, a control channel for the extension carrier may be configured as follows.

a-1) a carrier that does not include a control channel at all may be configured. In this example, a PCFICH may also not be included in the carrier.

a-2) unlike 1, a carrier may include a physical hybrid ARQ indicator channel (PHICH). A predetermined OFDM symbol (expected to be 1 OFDM symbol) may be occupied or a predetermined number of OFDM symbols may be occupied and thus, a PCFICH may not be separately required.

a-3) a carrier may selectively include a PHICH or have a selective format and thus, may require a PCFICH and a smaller amount of CFI information than an amount of information required, for example, information of 1 bit.

Accordingly, the extension carrier when resource allocation is performed by inter-CC scheduling is defined to be extension carrier Z. When a format of a control channel with respect to an extension carrier is set as described in a-1), a-2), and a-3), in cases a-1) and a-2), the extension carrier Z may not require information associated with a CFI, and a field assigned to store the information may be used for another purpose so that additional information of 2 bits may be transmitted. Also, in the case 1-3), additional information of 1 bit may be provided.

A plurality of carriers X or extension carriers Z may exist in the entire carrier aggregation when communication is performed through the carrier aggregation. It is because the carrier aggregation is performed so as to use one or more carriers, and the PDCCH configuration for each carrier is basic for resource allocation to a corresponding carrier. Therefore, a plurality of carriers X and extension carriers Z may exist, and information of 2 bits or more may be transmitted to a UE. The information may be separately used for each carrier or for each extension carrier, or may be combined in the entire carrier aggregation and may be used together.

The additional information transmission may be performed with respect to the carrier X and the extension carrier Z, and for the additional information transmission, the following items are set.

b-1) a predetermined value may be fixedly assigned. When the predetermined value is fixedly assigned, the fixed value may be used for a decoding process in a receiving end and thus, a decoding performance may be improved. In this example, additional information bits may be configured to be uniformly dispersed in the entire DCI format of the entire PDCCH.

b-2) information associated with a HARQ of a UL may be transmitted. That is, ACK/NACK information associated with a physical uplink shared channel (PUSCH) transmitted in an UL may be transmitted.

b-3) a number of other PDCCHs in a carrier may be indicated. For example, when a number of additional PDCCHs in addition to a PDCCH itself is indicated, it may be helpful to reduce a number of blind decodings in the carrier.

b-4) information of a PDCCH monitoring set may be transmitted. The PDCCH monitoring set may be a limited carrier subset to which decoding is applied from among the entire carriers aggregation, which is used to reduce a number of blind decodings. A portion of the information of the PDCCH monitoring set may be temporarily transmitted. That is, information maintained for a predetermined time may be transferred through upper layer signaling, and frequently changed information may be transmitted temporarily.

b-5) resource allocation information associated with a UL control channel may be transmitted. A resource allocated to the UL control channel may be extended to two or more resources from one existing resource. For the extension, an existing resource allocation may transmit information based on a location of a control information section of a DL control channel, and may transmit allocation information associated with resources added when the resources are extended to two or more resources.

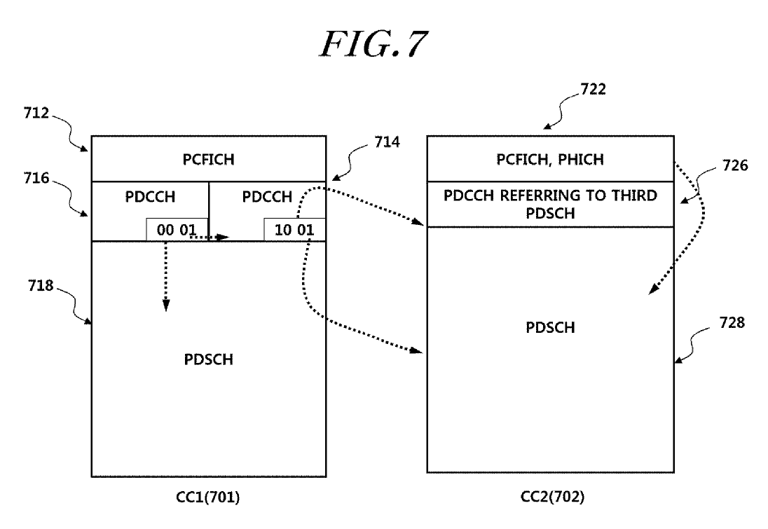

FIG. 7 illustrates inter-CC scheduling according to an embodiment of the present invention. This may be provided based on a signal configuration of FIG. 6. CC1 701 from among two CCs, that is, CC1 701 and CC2 702, may correspond to a CC that includes control information associated with the CC itself and another CC. Two PDCCHs 714 and 716 of CC1 701 may provide resource allocation information of CC2 and resource allocation information of CC1, respectively. In the PDCCH 714 that includes the resource allocation information of CC2, a value of a field in which a CFI and a CI (CC identification information) are combined may be 1001, and the last 2 bits correspond to identification information indicating CC2 702 and the first 2 bits may include CFI information corresponding to information associated with resource allocation in CC2 702. When CC1 701 is decoded without an error, data resource (PDSCH) 728 of CC2 702 may be decoded even when an error occurs in a PCFICH 722 in a process of decoding CC2 702. A PDCCH 716 including resource allocation information of CC1 701 may have a value of 0001. A CFI may not need to be separately included and thus, the first 2 bits of ‘0001’ of the PDCCH 716 may indicate that ‘00’ is not used as a value of the CFI and a PDSCH is included in the same CC. Accordingly, various values may be set with respect to the last 2 bits. For example, as described in the foregoing, 1) signal information to be used for decoding may be added, or 2) ACK/NACK information associated with a HARQ may be included. Also, information associated with another PDCCH in the carrier or information associated with a UL may be included. Referring to FIG. 7, the last 2 bits may be set to be ‘01’ so as to indicate a number of other PDCCHs in the carrier.

Information provided by the control channel PCFICH of CC2 702 of FIG. 7 may be provided by CC1 701 and thus, a PCFICH may be selectively included in a carrier. Also, a PHICH may be included in the carrier along with the PCFICH. Also, a PDCCH 726 may be included in the carrier so as to decode a third PDSCH. The third PDSCH may be included in CC2 or a third CC. Also, an extension carrier may be configured by excluding a PDCCH from CC2 702 of FIG. 7.

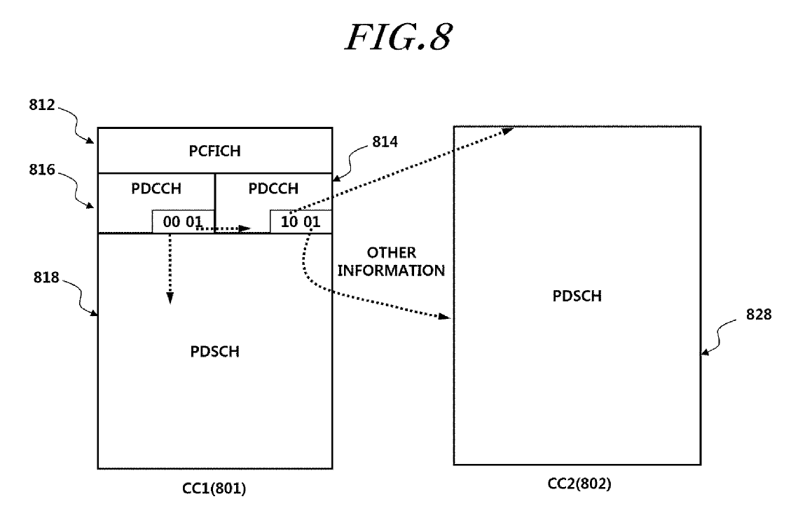

FIG. 8 illustrates a case in which a control channel is not included in an extension carrier according to another embodiment of the present invention. Referring to FIG. 8, a PDCCH 816 that is in charge of resource allocation in the same CC may have the same configuration as the PDCCH 716 of FIG. 7 and thus, detailed descriptions thereof will be omitted.

A PDCCH 814 including resource allocation information of another CC may allocate a resource to CC2 802, and a CFI with respect to a PDSCH 828 may be set to 10. A control channel is not separately included in CC2 802 and thus, information of the PDSCH 828 may be decoded through only CC1 801. Accordingly, the CFI may not be required. In this example, ‘01’ assigned as a value of the CFI may indicate separately predetermined information. For example, control information associated with CC1 801 or control information associated with CC2 802 may be included. As an example of the control information, c-1) a predetermined value required for a process of decoding CC2 802 may be fixedly assigned so as to improve a decoding performance, and c-2) HARQ information of a UL of CC2 802 may be transmitted. Also, c-3) a number of other PDCCHs included in CC1 801 may be indicated and (c-4) information associated with a PDCCH monitoring set may be transmitted. In addition, c-5) resource allocation information associated with a UL control channel may be transmitted. In addition, various control information may be included. The control information may not be limited to a predetermined CC, CC1 801 or CC2 802. In FIG. 8, the embodiment has been described based on an extension carrier.

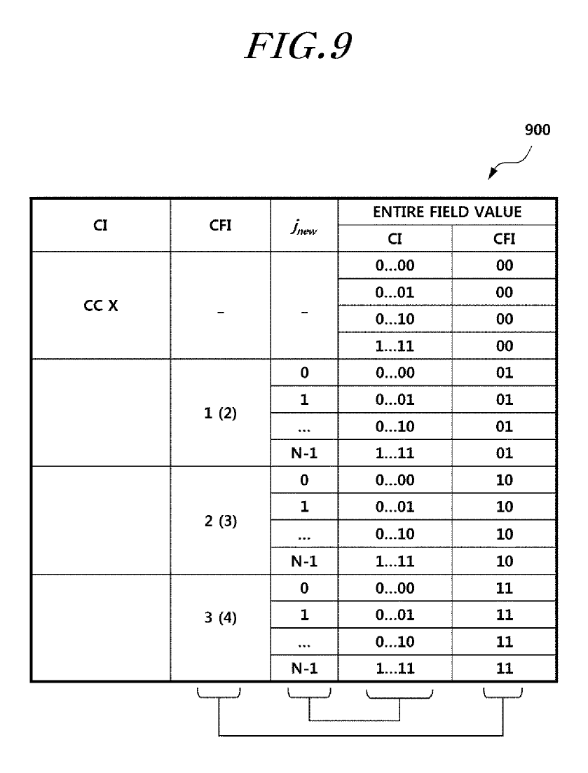

FIG. 9 illustrates an example in which a CFI and a CI are combined and provided when a number of CCs is N according to an embodiment of the present invention. The number of CCs is N and thus, N−1 pieces of information may need to be expressed so as to generate identification information to identify CCs. Accordingly, bits corresponding to a length of an integer ┌log₂(N−1)┐ that is greater than a value obtained through log₂(N−1) and is cloest to the value may be required, and may be expressed as shown in 900 when the bits required is combined with a CFI. A CI may be obtained through Equation 1 and Equation 2. In 900, a value of the entire field including the CI expressed by bits having the length of ┌log₂(N−1)┐ and the the CFI, is shown. A length of the entire field may be ┌log ₂(N−1)┐+2.

In the example of FIG. 9, a CFI and a CI may be included in a separate control channel, in addition to a PDCCH. For example, the CFI and the CI may be added to a control channel such as a PCFICH, a PHICH, and the like. When a separate control channel is provided to perform scheduling for a plurality of CCs, the CFI and the CI may be included in the corresponding control channel. Modifications may be variously made in a process of embodying the invention, and the invention may not be limited to the PDCCH.

Also, a CC and a CFI may be embodied in a field without having an independent bit location.

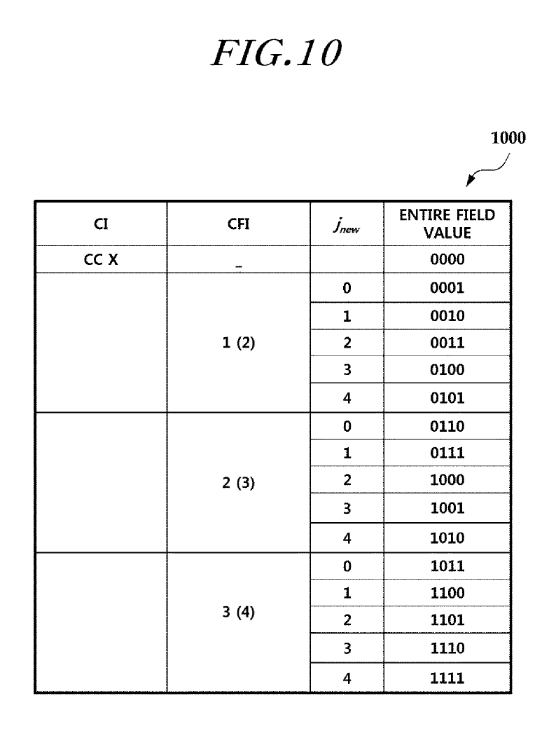

FIG. 10 illustrates a value set in a field when a number of CCs is 6 and a CFI includes three types of information according to an embodiment of the present invention. When the number of CCs is 6 and inter-CC scheduling is performed, for a CC X, a CFI may not be separately required. Accordingly, ‘0000’ is assigned. For other CCs, information may be effectively provided by arranging identification information j_{new} and CFIs and uniformly mapping bits.

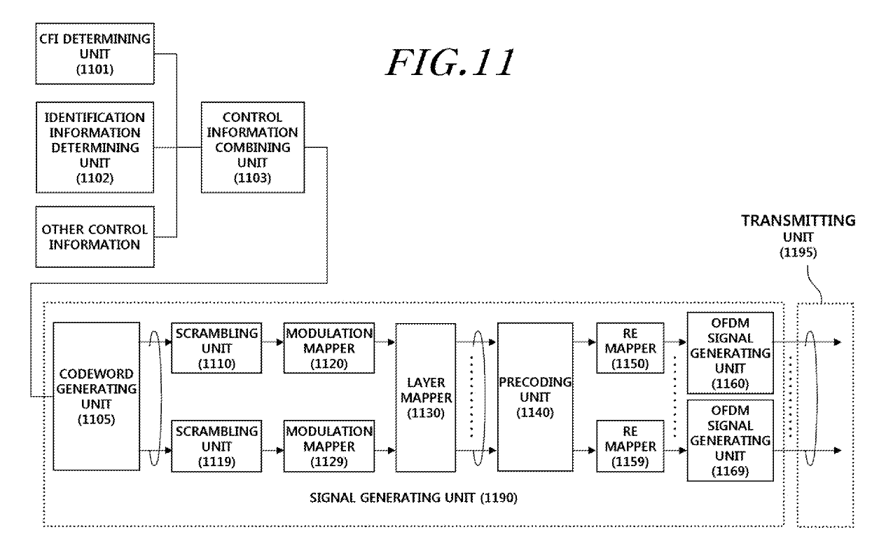

FIG. 11 illustrates a process of generating DL control information in a base station according to an embodiment of the present invention.

Referring to FIG. 11, a first CC is a CC corresponding to CC1 of FIGS. 1, 7, and 8, and may include control information, and may include data allocation information of another CC (a second CC) or indication information to indicate the second CC, since data information is included in the second CC.

A CFI determining unit 1101 may determine a CFI value of a CC. In a case of the CC X corresponding to the first CC to which data is assigned, the CFI value may not need to be determined. Accordingly, as described in the foregoing, the CFI value may be set to be a predetermined value, for example, a value that may not be used as the CFI value.

When data is assigned to the second CC, a CFI value of the second CC may be determined. As described in the foregoing, the CFI value may be determined based on a bandwidth. For example, when a number of resource block groups of the entire band of a DL is greater than 10, the CFI value may have a value in a range of 1 through 3, and when the number of resource block groups is less than or equal to 10, the CFI value may have a value in a range of 2 through 4.

An identification information determining unit 1102 may determine a CI corresponding to indication information for a CC.

A control information combining unit 1103 may perform a process of combining other control information, a CI, and a CFI value. The control information combining unit 1103 may combine the CFI value and other control information required by a control channel such as a PDCCH, in addition to the CI corresponding to indication information associated with a CC. The CFI determining unit 1101 that generates control information, the identification information determining unit 1102, and the control information combining unit 1103 may be configured as a single module and may provide functions, or may be configured to be separate modules and provide functions.

As described in the foregoing, the CC x corresponding to the first CC to which data is assigned may not use the CFI value and thus, a predetermined value may be set in advance. There is no need to indicate another CC and thus, the CI, which is one of the control information, may include a value of another piece of information. For example, a predetermined value may be fixedly assigned so that a UE uses the predetermined value for a decoding process or HARQ information of a UL may be provided. A number of other PDCCHs in the first CC may be indicated, or information of a PDCCH monitoring set may be included. Also, information associated with a resource of a UL control channel may be included. Among the above examples, predetermined information may be determined to be a CI value and may be combined with the CFI value.

However when data is not assigned to the first CC and the data is assigned to the second CC, the control information may include information associated with the second CC. Also, as described in the foregoing, CI information and CFI information associated with the second CC may be combined.

The information combining unit 1102 may combine information in a bit format as described in FIGS. 5, 6, 9, and 10. The combined information may be generated by the codeword generating unit 1105 as a codeword. The generated information may be scrambled by the scrambling units 1110 through 1119. Blocks of the scrambled bits may be modulated to be a symbol based on a predetermined modulation scheme of modulation mappers 1120 through 1129. The modulation may include biphase shift keying (BPSK), quadrature phase shift keying (QPSK), and the like. When combined control information is included in a PDCCH and is transmitted, modulation may be performed through the QPSK.

The symbols may be mapped to various layers by a layer mapper 1130. In this process, when a single antenna port is used for transmission, the symbols may be mapped to a single layer for transmission. Conversely, when a plurality of antenna ports is used for transmission, a multi-antenna transmission scheme may be used. The layer mapping may be performed through use of the multi-antenna transmission scheme such as a spatial multiplexing or a transmit diversity.

When the layer mapping is completed, a precoding unit 1140 may generate a vector block so that mapping is performed on resources based on a mapping scheme of an antenna port. A precoding scheme may be determined based on a number of antennas determined by the layer mapping and a multi-antenna mapping scheme.

When the precoding is completed, resource element (RE) mappers 1150 through 1159 may perform mapping with respect to REs. When the mapping is completed, OFDMs generated by the OFDM signal generating units 1160 through 1169 may be transmitted through an antenna port of a transmitting unit 1195.

The signal generating process of FIG. 11 may be embodied within a single module. The codeword generating unit 1105, the scrambling units 1110 through 1119, the modulation mappers 1120 through 1129, the layer mapper 1130, the precoding unit 1140, the RE mappers 1150 through 1159, and the OFDM signal generating units 1160 through 1169 may be included in a signal generating unit 1190 as separate modules as illustrated in FIG. 11, or two or more of them may be combined and performed as a single module.

In the signal generating process of FIG. 11, a precoding process is omitted in a process of generating a PDCCH and thus, an input and an output of the precoding may be the same. Also, after generating a codeword, the process may not proceed with multiple routes. To generate a PDCCH control channel, a tailbiting convolutional coding (TCC) may be used, and an operation associated with a rate matching (RM) may be applied.

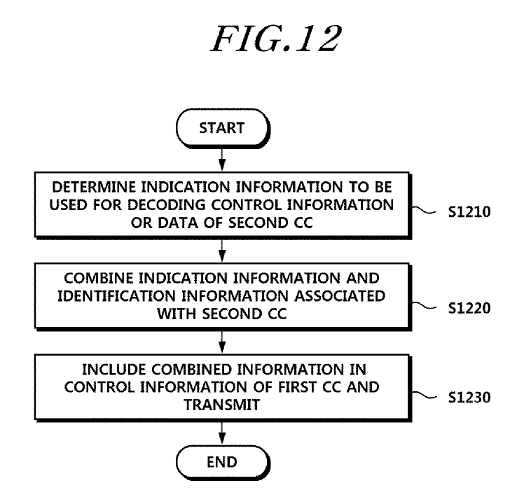

FIG. 12 illustrates a process of generating control information in a base station according to an embodiment of the present invention.

The base station may transmit, to a UE, control information through a first CC and may transmit data through a second CC. Here, the first CC and the second CC may be the same as or different from one another.

The base station may determine indication information to be used for decoding at least one of control information and/or data of the second CC (step S1210). As described in the foregoing, when the second CC is different from the first CC, the second CC may be an extension CC, and a CFI required for decoding the data in the second CC may be determined. Conversely, when the second CC is the same as the first CC, that is, in a case of a CC X and thus, a CFI may have a predetermined value. The base station may combine identification information associated with the second CC and the indication information (step S1220). When the second CC is different from the first CC, identification information associated with a corresponding CC, for example, j_{new} of FIGS. 4, 5, 6, 9, and 10, and indication information such as a CFI may be combined. Conversely, when the second CC is the same as the first CC, for example, in a case of the CC X, various predetermined information, for example, a number of pieces of control information such as PDCCHs included in the same CC, information associated with a HARQ of a UL, information required for performing decoding in the UE, and the like, may be included.

The base station may include the combined information in the control information of the first CC and transmit it (step S1230). When the second CC is different from the first CC, the second CC may not include the indication information. In particular, the second CC may be configured to not include a PCFICH, or may be configured to include only a PHICH, or may be configured to include only a PDSCH.

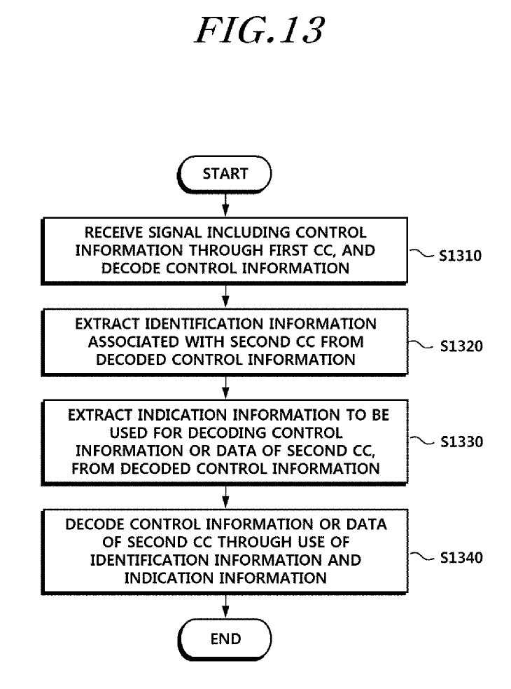

FIG. 13 illustrates a process of decoding control information in a UE according to an embodiment of the present invention.

A process in which a UE receives, from a base station, control information through a first CC, and receives data through a second CC, is provided. Here, the first CC and the second CC may be the same as or different from one another.

The UE may receive a signal including the control information through the first CC, and may decode the control information (step S1310). Examples of the control information may include a PDCCH. The UE may extract identification information associated with the second CC from the decoded control information (step S1320). The identification information may denote information to be used for identifying a CC, for example, j_{new} of FIGS. 4, 5, 6, 9, and 10. The UE may extract indication information to be used for decoding at least one of control information and data of the second CC from the decoded control information (step S1330). The indication information may be a CFI. When the first CC and the second CC are the same as one another, for example, in a case of a CC X, the indication information may be various predetermined information, for example, a number of pieces of control information such as PDCCHs included in the same CC, information associated with a HARQ of a UL, and information required for performing decoding in the UE, and the like.

Through use of the identification information and the indication information, the UE may decode the control information or the data of the second CC (step S1340). When the second CC is different from the first CC, the second CC may not include the indication information and thus, the UE may decode the data of the second CC by decoding the control information of the first CC. In particular, the second CC may be configured to not include a PCFICH, or may be configured to include only a PHICH, or may be configured to include only a PDSCH. Also, when the second CC includes control information and an error occurs during transmission of the control information, the data of the second CC may be decoded through use of the decoded control information of the first CC.

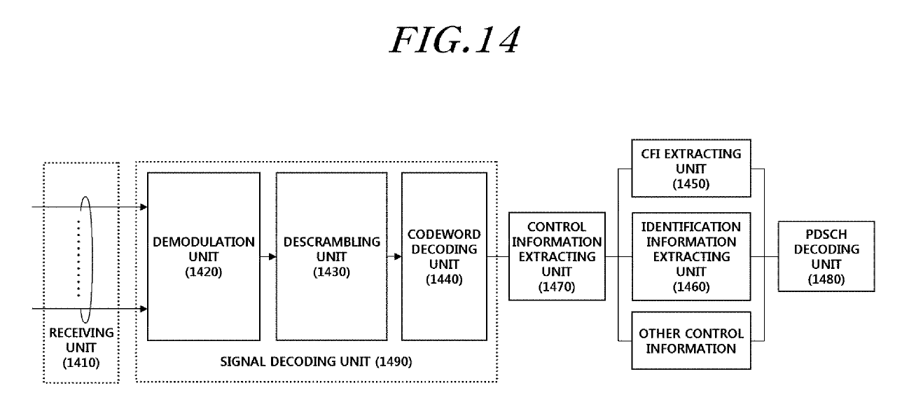

FIG. 14 illustrates a configuration of a UE according to an embodiment of the present invention.

Many pieces of information may be combined with a control signal and may be transmitted and thus, the UE may decode the information so as to determine resource allocation with respect to a plurality of CCs or to extract predetermined information. The UE may have functions for receiving control information through a first CC and for receiving data through a second CC.

A receiving unit 1410 may receive a signal from a base station. The receiving unit 1410 may include a single antenna, or may provide a multiple antenna reception function through two or more antennas.

A demodulation unit 1420 may provide a function of demodulating the received signal. According to an embodiment of the present invention, when the base station transmits an OFDM signal, demodulation may be performed based on an OFDM scheme. Also, based on whether the signal generated by the base station is associated with an FDD scheme or a TDD scheme, the demodulation may be performed based on a corresponding scheme.

The demodulated signal may be descrambled by a descrambling unit 1430 and thus, a codeword of a predetermined length may be generated. A codeword decoding unit 1440 may decode the codeword into predetermined information. The functions may be performed in a signal decoding unit 1490, or may be performed independently and sequentially by two or more modules.

The decoded signal may include the entire field value of FIGS. 5, 6, 9, and 10 and other control information. A control information extracting unit 1470 may provide information to a corresponding module so that identification information associated with the second CC and indication information to be used for decoding control information or data of the second CC may be extracted from the decoded signal. Accordingly, an identification information extracting unit 1460 to extract identification information associated with the second CC, for example, a CI, and a CFI extracting unit 1450 to extract indication information to be used for decoding the control information or the data of the second CC, may perform extracting of corresponding information. The control information extracting unit 1470 may extract control information, in addition to control information extracted by the identification information extracting unit 1460 and the CFI extracting unit 1450. Through use of the extracted identification information, the indication information, and the other control information, the data or the control information of the second CC may be decoded. The data or the control information of the second CC may be decoded by a PDSCH decoding unit 1480. The PDSCH decoding unit 1480 is provided as an example, and may decode data information or control information based on a configuration. Also, the signal decoding unit 1490 may be provided with the decoded identification information, the indication information, and the control information, so as to decode a PDSCH. The CFI extracting unit 1450, the identification information extracting unit 1460, and the control information extracting unit 1470 that extract the indication information, the identification information, and other control information from the decoded signal may be configured to be a single module or may be configured to be separate modules.

As described in the foregoing, when the first CC and the second CC are the same as one another, the identification information may include information required for decoding data of the first CC, information associated with a number of pieces of control information of the first CC, and the like.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method for combining and transmitting control information to enable a base station (BS) that performs transmission and reception of control information and data information with a user equipment (UE) through a plurality of component carriers (CCs) to transmit control information to the UE through a first CC and to transmit data information through a second CC identified by the control information of the first CC, the method comprising:
determining identification information to identify the second CC;
determining indication information for decoding at least one of the data information and control information of the second CC;
combining the identification information to identify the second CC with the indication information; and
transmitting combined information by including the combined information in the control information of the first CC.

2. The method as claimed in claim 1, wherein the identification information to identify the second CC is determined based on the first CC.

3. The method as claimed in claim 1, wherein the indication information is resource allocation information for decoding a physical downlink shared channel (PDSCH) of the second CC, and the data information of the second CC is included in the PDSCH.

4. The method as claimed in claim 1, wherein when the first CC and the second CC are the same as one another, the identification information to identify the second CC includes information associated with a number of pieces of control information allocated to the first CC as resources.

5. The method as claimed in claim 1, wherein when the first CC and the second CC are the same as one another, the identification information associated with the second CC includes information associated with a hybrid automatic request (HARQ) associated with an uplink (UL) of the first CC.

6. The method as claimed in claim 1, wherein when the first CC is different from the second CC, the second CC does not include the indication information.

7. The method as claimed in claim 1, wherein when the first CC and the second CC are the same as one another, the identification information associated with the second CC includes resource allocation information with respect to an uplink (UL) control channel of the first CC.

8. A method for combining and transmitting control information to enable a base station (BS) that performs transmission and reception of control information and data information with a user equipment (UE) through a plurality of component carriers (CCs) to transmit control information and data information to the UE through a first CC, the method comprising:
determining indication information;
combining, with the indication information, identification information including control information associated with data information to be transmitted and received or a CC; and
transmitting the combined information by including the combined information in the control information of the first CC.

9. A method for combining and transmitting control information to enable a base station (BS) that performs transmission and reception of control information and data information with a user equipment (UE) through a plurality of component carriers (CCs) to transmit control information to the UE through a first CC and to transmit data information through a second CC identified by the control information, the method comprising:
determining identification information to identify the second CC;
combining, with the identification information, indication information including control information associated with information to be transmitted and received or a CC; and
transmitting the combined information by including the combined information in the control information of the first CC.

10. A method for combining and receiving control information to enable a user equipment (UE) that performs transmission and reception of control information and data information with a base station (BS) through a plurality of component carriers (CCs) to receive control information from the BS through a first CC and to receive data information through a second CC identified by the control information, the method comprising:
decoding control information by receiving a signal including the control information through the first CC;
extracting, from the decoded control information, identification information to identify the second CC;
extracting, from the decoded control information, indication information to be used for decoding at least one of the data information and control information of the second CC; and
decoding at least one of the data information and the control information of the second CC through use of the identification information and indication information.

11. The method as claimed in claim 10, wherein the identification information to identify the second CC is determined based on the first CC.

12. The method as claimed in claim 10, wherein the indication information is resource allocation information for decoding a physical downlink shared channel (PDSCH) of the second CC.

13. The method as claimed in claim 10, wherein when the first CC and the second CC are the same as one another, the identification information to identify the second CC includes information associated with a number of pieces of control information allocated to the first CC as resources.

14. The method as claimed in claim 10, wherein when the first CC and the second CC are the same as one another, the identification information to identify the second CC includes information associated with a hybrid automatic request (HARQ) associated with a uplink (UL) of the first CC.

15. The method as claimed in claim 10, wherein when the first CC is different from the second CC, the second CC does not include the indication information.

16. The method as claimed in claim 10, wherein when the first CC and the second CC are the same as one another, the identification information to identify the second CC includes resource allocation information with respect to an uplink (UL) control channel of the first CC.

17. A method for combining and receiving control information to enable a user equipment (UE) that performs transmission and reception of control information and data information with a base station (BS) through a plurality of component carriers (CCs) to receive control information and data information, the method comprising:
decoding control information by receiving a signal including the control information through a first CC;
extracting indication information from the decoded control information; and
extracting identification information including control information associated with information to be transmitted and received or a CC from the decoded control information when the indication information indicates that data is transmitted through the first CC.

18. A method for combining and receiving control information to enable a user equipment (UE) that performs transmission and reception of control information and data information with a base station (BS) through a plurality of component carriers (CCs) to transmit control information through a first CC and to receive data through a second CC identified by the control information, the method comprising:
decoding control information by receiving a signal including the control information through the first CC;
extracting identification information from the decoded control information; and
extracting, from the decoded control information, indication information including control information associated with information to be transmitted and received or a CC when the identification information includes identification information to identify the second CC and the second CC is an extension carrier.

19. An apparatus for to combine and transmit control information to enable a base station (BS) that performs transmission and reception of control information and data information with a user equipment (UE) through a plurality of component carriers (CCs) to transmit control information to the UE through a first CC and to transmit data information through a second CC identified by the control information of the first CC, the apparatus comprising:
a control format indicator (CFI) determining unit to determine indication information to be used for decoding at least one of data and control information of the second CC;
an identification information determining unit to determine identification information to identify the second CC;
a control information combining unit to combine the indication information, the identification information, and other control information;
a signal generating unit to generate the combined information to be a wireless signal; and
a transmitting unit to transmit the generated wireless signal.

20. An apparatus to combine and receive control information to enable a user equipment (UE) that performs transmission and reception of control information and data information with a base station (BS) through a plurality of component carriers (CCs) to receive control information from the BS through a first CC, and to receive data information through a second CC identified by the control information, the apparatus comprising:
a receiving unit to receive a signal including control information through the first CC;
a signal decoding unit to decode the received signal into the control information;
an identification information extracting unit to extract identification information to identify the second CC from the decoded control information;
a control format indicator (CFI) extracting unit to extract, from the decoded control information, indication information to be used for decoding at least one of data and control information of the second CC; and
a control information extracting unit to extract, from the decoded control information, information excluding the identification information and the indication information,
wherein the signal decoding unit decodes at least one of the data and the control information of the second CC through use of the identification information and the indication information.

21. A method for combining and transmitting control information to enable a base station (BS) that performs transmission and reception of control information and data information with a user equipment (UE) through a plurality of component carriers (CCs) to transmit control information to the UE through a first CC, and to transmit data information through a second CC identified by the control information of the first CC, the method comprising:
calculating identification information j_{new} to identify the second CC through use of identification information i_{CC}_{_{—}}_{X} associated with the first CC and existing identification information j associated with the second CC; and
transmitting the identification information j_{new} to identify the second CC by including the identification information _{new} in the control information of the first CC,
wherein the identification information j_{new} is calculated to have a number in a range smaller than j based on j and i_{CC}_{_{—}}_{X}.

22. The method as claimed in claim 21, wherein calculating of the identification information j_{new} to identify the second CC comprises:
performing calculation through use of d corresponding to a total number of CCs, and an equation j_{new}=(j−i_{CC}_{_{—}}_{X}+d−1)%(d−1).

23. The method as claimed in claim 21, wherein calculating of the identification information j_{new} to identify the second CC comprises:
comparing a size between identification information i_{CC}_{_{—}}_{X} associated with the first CC and existing identification information j associated with the second CC; and
calculating j as a value of the identification information j_{new} to identify the second CC when j is less than i_{CC}_{_{—}}_{X}, and calculating a value obtained by subtracting 1 from j as the identification information j_{new} to identify the second CC when j is greater than i_{CC}_{_{—}}_{X}.

24. A method for combining and receiving control information to enable a user equipment (UE) that performs transmission and reception of control information and data information with a base station (BS) through a plurality of component carriers (CCs) to receive control information through a first CC, and to receive data information through a second CC identified by the control information, the method comprising:
decoding control information by receiving a signal including the control information through the first CC;
calculating an existing identification number j associated with the second CC from the decoded control information j_{new} through use of identification information i_{CC}_{_{—}}_{X} associated with the first CC; and
receiving data information through the second CC indicated by the calculated j,
wherein j is a number in a range greater than or equal to j_{new}.

25. The method as claimed in claim 24, wherein calculating of the existing identification information j comprises:
calculating j that satisfies d corresponding to a total number of CCs, and an equation j_{new}=(j−i_{CC}_{_{—}}_{X}+d−1)%(d−1).

26. The method as claimed in claim 24, wherein calculating of the existing identification information j associated with the second CC comprises:
comparing the identification information i_{CC}_{_{—}}_{X} associated with the first CC and the decoded control information j_{new}; and
calculating j_{new} as a value of the existing identification information j associated with the second CC when j_{new} is smaller than i_{CC}_{_{—}}_{X}, and calculating a value obtained by adding 1 to j_{new} as the existing identification information j associated with the second CC when j is greater than or equal to i_{CC}_{_{—}}_{X}.
